(19) United States
(12) Patent Application Publication
(10) Pub. No.: US 2025/0145043 A1
(43) Pub. Date: May 8, 2025

(54) MULTI-PORT AND MULTI-MODULE FAST ELECTRIC VEHICLE (EV) CHARGING STATION AND METHOD OF ADAPTIVE POWER MANAGEMENT

(71) Applicant: Qatar Foundation for Education, Science and Community Development, Doha (QA)

(72) Inventors: Ali Sharida, Doha (QA); Haitham Abu-Rub, Doha (QA); Sertac Bayhan, Doha (QA)

(21) Appl. No.: 18/931,913

(22) Filed: Oct. 30, 2024

Related U.S. Application Data
(60) Provisional application No. 63/547,502, filed on Nov. 6, 2023.

(51) Int. Cl. B60L 53/63; B60L 53/16; B60L 53/30; B60L 53/66

(52) U.S. Cl. CPC B60L 53/63; B60L 53/16; B60L 53/30; B60L 53/66

(57) ABSTRACT

The Disclosed technology proposes a novel fast Electric Vehicle (EV) charging topology with adaptive power management and power sharing between different ports and different charging stations to fulfill the wide range and high charging power requirements of EV chargers. The proposed charging station topology consists of two charging ports, each port consisting of N number of parallel modules. Each module consists of a cascaded T-type AC/DC converter and dual active bridge (DAB) converter. These modules are distributed equally over two charging ports with the ability to reconfigure this distribution adaptively to fulfill the power requirements on each port.

### RELATED APPLICATIONS

The present disclosure claims priority to U.S. Provisional Patent Application 63/547,502 having a filing date of Nov. 6, 2023, the entirety of which is incorporated herein.

### BACKGROUND

Nowadays, commercial fast Electric Vehicle (EV) charging stations are unidirectional consisting of controlled rectifier (AC-DC side) and a full diode bridge with LLC converter. This design is considered the cheapest solution as the number of power switches is reduced, and the most reliable, as the diodes are less exposed to faults than power electronic switches. However, this topology has low efficiency, has no internal storage nor a support to add a new one, does not provide ancillary services to the grid, and does not support most of the required services. Moreover, existing EV charging stations are not designed to provide reconfiguration of the charging ports. As a result, there are no commercial solutions available for adaptive power and energy management between ports and units for EV chargers.

However, numerous power management techniques were proposed in literature for managing the power fed or consumed from the EV chargers, such as integrating photovoltaic (PV) panels with the EV charger, power management of EV chargers for reliability and interfacing AC grid, mitigating charging impact on the power grid, EV chargers power management for improving power quality of the power grid, energy management systems for home energy hubs to charge plug-in EVs, and coupling the EV charging stations using hardware circuits. However, none of these solutions considered the adaptive power management inside the charging unit itself. In terms of multi-port EV chargers' topologies, numerous topologies and infrastructures have been proposed in the literature. However, a need still exists for EV charging stations that are adaptively reconfigurable, optimized, or able to share power with other ports or units.

### SUMMARY

According to one non-limiting aspect of the present disclosure, an exemplary embodiment of an Electric Vehicle (EV) charging station including at least two charging ports, where each charging port is includes N number of parallel modules, and where each parallel module includes a T-type AC/DC converter and dual active bridge (DAB) converter. In one embodiment, the parallel modules are distributed equally over two charging ports with the ability to reconfigure this distribution adaptively to fulfill the power requirements on each port.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1 is a circuit diagram of the proposed topology of the disclosed technology, according to an example embodiment of the present disclosure.

FIG. 2 shows a response of the charging system without the proposed adaptive power management in the Disclosed technology, according to an example embodiment of the present disclosure.

FIG. 3 shows the disclosed technology in a configuration where port 1 is supporting port 2 by one module, according to an example embodiment of the present disclosure.

FIG. 4 shows the disclosed technology in a configuration where port 2 is supporting port 1 by one module, according to an example embodiment of the present disclosure.

FIG. 5 shows ports overloading when the support from neighboring port is not available, according to an example embodiment of the present disclosure.

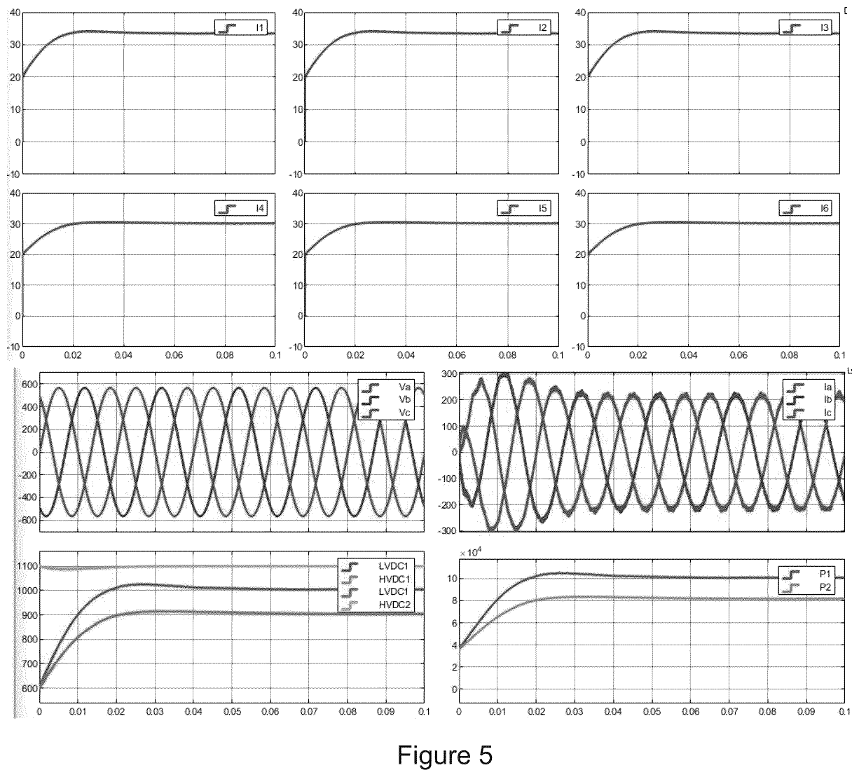

### DETAILED DESCRIPTION

The present disclosure generally relates to a multi-port and multi-module fast Electric Vehicle (EV) charging station and method of adaptive power management.

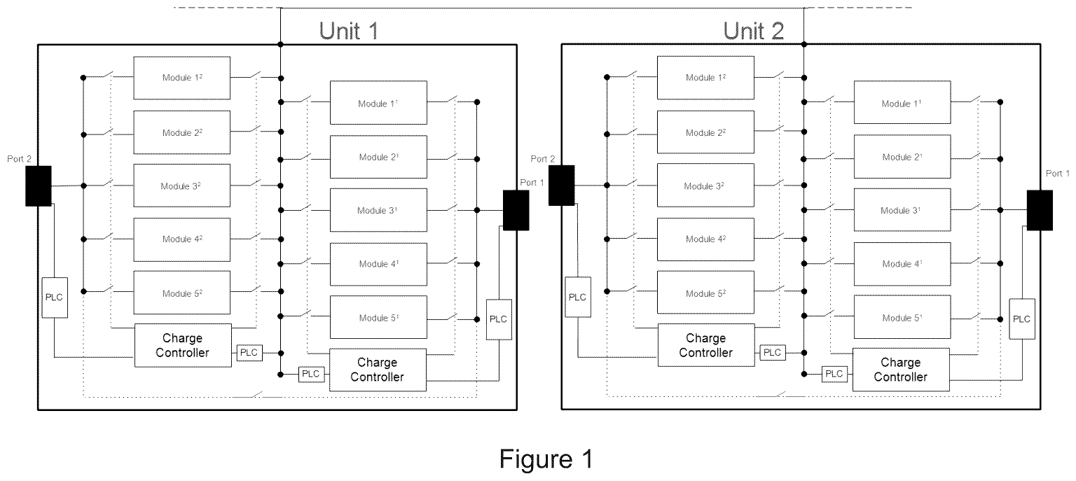

The disclosed technology proposes a novel fast Electric Vehicle (EV) charging topology with adaptive power management and power sharing between different ports and different charging stations to fulfill the wide range and high charging power requirements of EV chargers. The proposed charging station topology consists of two charging ports, each port consisting of N number of parallel modules. Each module consists of a cascaded T-type AC/DC converter and dual active bridge (DAB) converter. These modules are distributed equally over two charging ports with the ability to reconfigure this distribution adaptively to fulfill the power requirements on each port as shown in FIG. 1.

Unlike conventional topologies, the disclosed technology allows borrowing some of the idle (the converters that are currently not participating in any charging process) modules between the under-loaded and overloaded ports in the same charging station or different stations by the mean of adaptive negotiation. This provides numerous advantages related to the capacity, cost, reliability, availability, and the rated power of the charging system. In terms of capacity and power ratings, each port can borrow up to two-times of its rated power from its neighboring port, and up to 2-Y (number of stand-alone stations multiplied by 2 as each one has two ports) its rated power from neighboring stations. As each port can borrow extra power from its neighbors, there is no need to oversize each module in order to fulfill the high charging power requirements. Therefore, the cost of the power electronic components is reduced significantly, leading to reducing the cost of the entire system. If one or more of the modules have faults or they are in use, the corresponding charging port can borrow the required power from its neighboring ports or charging stations, leading to enhancing the reliability during faults and the availability when other ports are in use.

Moreover, this Disclosed technology proposes adaptive power sharing, energy management, and supporting modules selection to achieve maximum possible power quality, charging efficiency, and operating lifetime. It is well-known that a power electronic converter provides the maximum power, quality, and efficiency at its rated power. However, it is not possible to exactly operate all converters at their rated power all the time. Instead, the power shared by each converter can be optimized to be closer to the rated value. In addition, to avoid degrading one or more of the converters more than the others, an optimization and selection technique for charging process participating converters is designed based on the total energy shared by each module. Then using KNN (K nearest neighbor) algorithm, the participating modules, supporting modules, and the amount of shared power are optimized. This technique avoids faster degradation of one or more of the modules than the others.

The Disclosed technology proposes power and energy management to manage the power flow between ports and charging units. When an EV is connected to a charging port, the EV will send the required charging parameters to the charging controller of the connected port through power line communication (PLC). The port in turn will compare the required charging power with the available (150 KW) power. As a result of this comparison, three possible cases are available.

In the first case, the connected port is sufficient to charge the EV. In this case, the charging controller of this port will use the reference power to decide the number of participating modules (X), the energy measurements of its modules to decided which modules will participate in the charging process, and the amount of power that will be shared by each one. The number of the participating module can be computed as follows,

$$X = ceil ( \frac{{P}^{*}}{{P}_{r}} )$$

Where X is the number of participating modules, P* is the reference charging power, and Pᵣ is the rated power of each attached module (30 KW). After that, the X modules that have the least energy measurements are selected to accomplish the charging process. Finally, the amount of power shared by each module (Ps) is computed as follows,

$${P}_{r} = \frac{{P}^{*}}{X}$$

In the second case, the connected port is not sufficient, but the neighbor port has sufficient idle-converters and can share the required power. If the available power of the connected port is not sufficient to charge the battery of the EV, then the connected port charging controller will ask for the support from its neighbor port. The charging controller of the neighbor port will approve this request and assign a sufficient number of modules to support the connected port using similar process shown in case 1. The neighbor charging controller will continuously receive the charging parameters (high voltage DC (HVDCv), low voltage DC (LVDCv), low voltage current (LVDCi), and reference power), and control the supporting modules independently from the other modules in the same port.

In the final case, the connected port is not sufficient, and the neighbor port has no sufficient or no idle-converters. In this case, the connected port will broadcast a supporting-request packet to all charging units. This packet will contain the required supporting power and the ID of the requesting port. Any station that can support (full or a fraction of the requested power support) will approve the request and reply with the available supporting power. After receiving the approval-packets from different units, the connected charging controller will send a final confirmation for the supporting units and triggers the charging process. During the charging, the connected charging controller will continuously send the charging parameters to the supporting units, which will control the supporting modules independently from the other modules.

The Disclosed technology's proposed topology and its management algorithms are implemented and validated using MATLAB/Simulink for all possible cases. To simplify results presentation, only three-modules are used for each charging port. The rated power of each module is 30 KW.

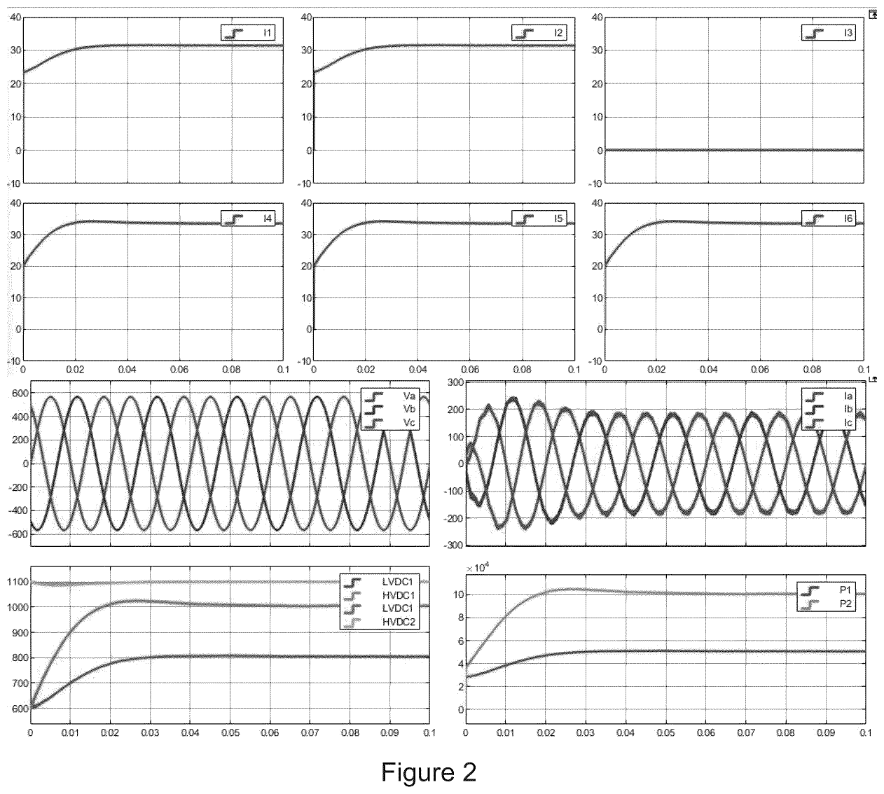

In the first test, one charging unit with two ports is used to show case 2, and for realistic demonstration, practical parameters of real EVs are used, where Nissan leaf is assumed to be connected to port 1 and Rolls-Royce Spectre at port 2. The HVDCv reference for each port is set to 1100V, 800V for LVDCv1, and 1000V for LVDCv2. The rated power Nissan leaf's battery is 50 KW, so two modules are required for port 1, and 1 module remains idle. On the other hand, the battery Rolls-Royce Spectre has a rated power of 100 KW, so 4 modules are required. Without using the proposed adaptive power management technique, Port 2 is overloaded in this case, while port 1 is under loaded as shown in FIG. 2.

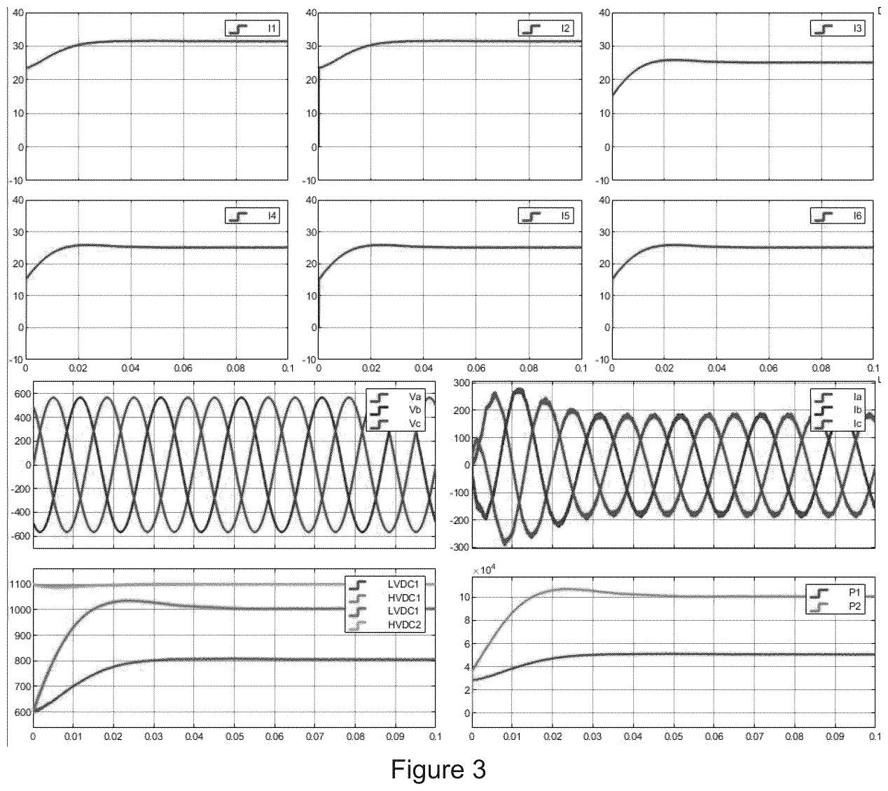

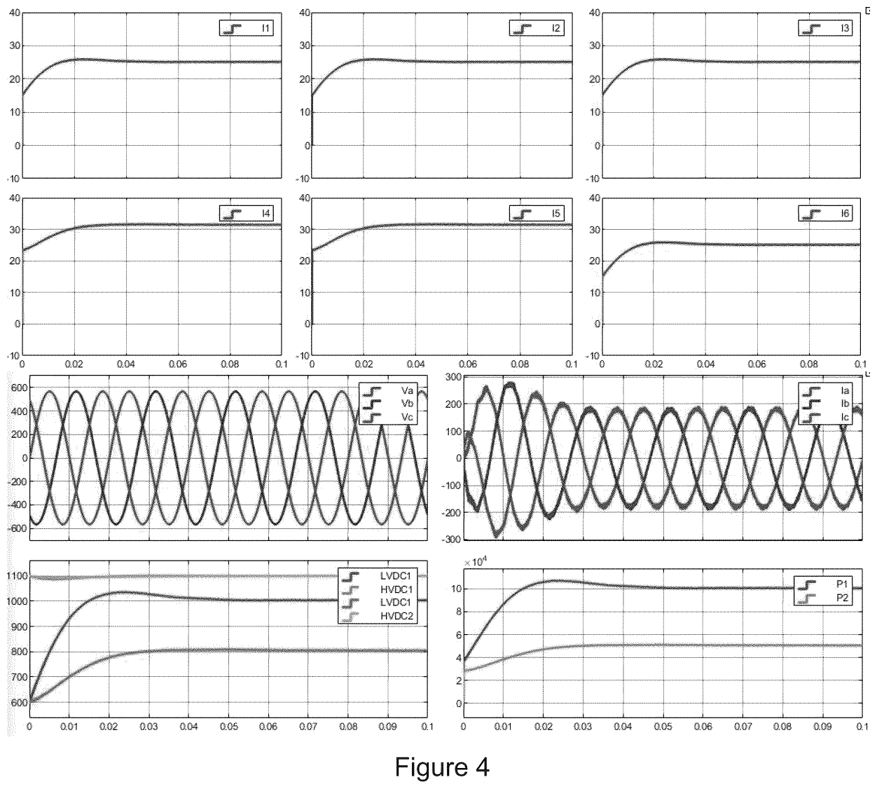

When the adaptive power management is enabled, Port 2 will use all his 3 modules and request the support from port1. Charge controller 1 (CC1) will receive the ratings from charge controller 2 (CC2) and send them to one of the idle modules of port 1. The supporting module is then connected to port 2, and controlled by CC1 using the reference signals received from CC2. The results of this case are shown in FIG. 3. It can be noticed that all modules are operating near to their rated power, none of them is overloaded, and module 3 of port 1 is now controlled by CC2. Similar to this case, if port 1 is overloaded, while port 2 is under-loaded, port 2 can support port 1 as shown in FIG. 4. In this case, it can be noticed that module 3 of port 2 is now controlled by CC1.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An Electric Vehicle (EV) charging station comprising: at least two charging ports, wherein each charging port is comprised of N number of parallel modules, and wherein each parallel module is comprised of a cascaded T-type AC/DC converter and dual active bridge (DAB) converter.

2. The Electric Vehicle (EV) charging station of claim 1, wherein the parallel modules are distributed equally over the at least two charging ports.

3. The Electric Vehicle (EV) charging station of claim 2, wherein the parallel modules have the ability to reconfigure distribution adaptively to fulfill the power requirements on each port of the at least two charging ports.

4. The Electric Vehicle (EV) charging station of claim 1, wherein the at least two charging ports are able to borrow power from each other.

5. The Electric Vehicle (EV) charging station of claim 1, wherein the at least two charging ports are able to borrow power from each other and from a second Electric Vehicle (EV) charging station.

6. The Electric Vehicle (EV) charging station of claim 5, wherein each of the at least two charging ports are able to borrow up to two-times of its rated power from each other, and wherein each of the at least two charging ports are able to borrow up to two times their rated power from the second Electric Vehicle (EV) charging station.

7. A method of adaptive power management of an electric vehicle charging station comprised of at least two charging ports, wherein each charging port is comprised of N number of parallel modules, and wherein each parallel module is comprised of a cascaded T-type AC/DC converter and dual active bridge (DAB) converter, the method comprising:
equally distributing the parallel modules over the at least two charging ports; and
reconfiguring the parallel modules.

8. The method of claim 7, further comprising redistributing the parallel modules adaptively to fulfill the power requirements on each port of the at least two charging ports.

9. The method of claim 8, further comprising the at least two charging ports borrowing power from each other and from a second Electric Vehicle (EV) charging station.

10. The method of claim 8, wherein the at least two charging ports borrow power using a power and energy management algorithm.

11. The method of claim 10, wherein the power and energy management algorithm, comprises:
getting reference signals from an electric vehicle, wherein the reference signals include the required power;
determining if the a port of the electric vehicle charging station can provide the required power;
computing the number of contributing parallel modules in the electric vehicle charging station;
selecting the contributing parallel modules based on power ratings and the total energy supplied by each parallel module;
setting the status of any remaining modules as “Idle”;
if a port cannot provide the required power, sending borrowing request to a charge controller to borrow modules from a second port;
proceeding with charging the electric vehicle with any available power;
if the charge controller receives borrowing request, checking the number of remaining modules with a status set to “Idle”;
selecting a number of reassigned modules from the number of remaining modules with a status set to “Idle”, wherein the number of reassigned modules are assigned to the port that cannot provide the required power; and
continuing to receive the reference signal and forwarding the reference signal to the reassigned modules.
